(19) United States
(12) Patent Application Publication
(10) Pub. No.: US 2013/0080659 A1
(43) Pub. Date: Mar. 28, 2013

(54) DEVICE AND METHOD FOR CONTROLLING USB TERMINAL

(71) Applicant: Hyung Su Seo, Gyeonggi-do (KR)

(72) Inventor: Hyung Su Seo, Gyeonggi-do (KR)

(73) Assignee: RSUPPORT Co., Ltd., Seoul (KR)

(21) Appl. No.: 13/544,833

(22) Filed: Jul. 9, 2012

(30) Foreign Application Priority Data
Sep. 23, 2011 (KR) 10-2011-0095992

(51) Int. Cl. G06F 3/00

(52) U.S. Cl. 710/5

(57) ABSTRACT

Provided are a device and method for controlling a Universal Serial Bus (USB) terminal. A control module senses that a terminal is connected through USB, provides a terminal control module for controlling the terminal through USB, and then provides a control command to the terminal control module through USB. The terminal control module executes the control command, and then captures and provides a display image of the execution result to the control module. Then, the control device displays the display image. Accordingly, it is possible to readily and rapidly control a mobile terminal by simply connecting the mobile terminal to the control device through USB.

CLAIM FOR PRIORITY

This application claims priority to Korean Patent Application No. 10-2011-0095992 filed on Sep. 23, 2011 in the Korean Intellectual Property Office (KIPO), the entire contents of which are hereby incorporated by reference.

### BACKGROUND OF INVENTION

1. Technical Field

Example embodiments of the present invention relate in general to control of a terminal connected through Universal Serial Bus (USB), and more particularly, to a method of controlling a USB terminal that can be applied to various mobile terminals having a USB interface and a device for performing the method.

2. Related Art

As the standard of input/output (I/O) interfaces connecting computers with peripherals, a USB interface has advantages such as ease of use, high-speed communication, high stability, generality, low implementation cost, low power consumption, and support for various operating systems (OSs).

Due to these advantages, the USB interface is being widely used as a connection means of digital cameras, external storage devices, mobile communication terminals, etc., as well as computer I/O devices, such as keyboards, mice, printers and scanners.

A computer and peripherals connected through the USB interface operate as a host and devices, respectively. A plurality of devices may be connected to one host.

Lately, with the development of processors, memory technology and communication technology, a mobile communication terminal having voice and video telephony functions, and also various functions such as still photography, moving picture photography, and Internet access, has been commercialized, and the USB interface with excellent communication speed, convenience, generality and extendability is used as a communication means between a personal computer (PC) and the mobile communication terminal.

For example, when a user upgrades an OS or firmware installed on a mobile communication terminal, or installs, removes or updates an application in the mobile communication terminal while using the mobile communication terminal, the user should first connect the mobile communication terminal to a computer through the USB interface, and then perform a desired operation through the computer.

At this time, the device driver of the mobile communication terminal should be installed on the computer such that the computer can recognize the mobile communication terminal as a USB device and perform normal communication after the computer and the mobile communication terminal are physically connected through the USB interface.

However, most users do not accurately know the process of installing a device driver of a mobile communication terminal and controlling the mobile communication terminal through a computer, thus causing inconvenience in use. Also, when the aforementioned process is incorrectly performed, there is a high probability that data stored in the mobile communication terminal will be deleted, or a serious error will occur.

Furthermore, since functions of a recent mobile communication terminal, such as a cellular phone, a smart phone or a pad-type terminal, are very complicated and advanced, there is a high probability of an error or failure occurring when the mobile communication terminal is used. When an error or failure occurs in such a mobile communication terminal, it is difficult for a common user with no expertise to find the cause of the error or failure, let alone correct it. Consequently, the user should request an expert or service center to diagnose and fix the trouble.

Conventionally, to diagnose a terminal in which an error has occurred and fix the error, a method of connecting the terminal to a computer through USB, inputting a command in the form of text through the computer, and personally checking the result obtained by executing the input command is performed. Consequently, it is difficult to accurately diagnose problems, much time is required, and there is inconvenience in the process of diagnosing and fixing problems.

### SUMMARY OF INVENTION

Accordingly, example embodiments of the present invention are provided to substantially obviate one or more problems due to limitations and disadvantages of the related art.

Example embodiments of the present invention provide a method of controlling a Universal Serial Bus (USB) terminal that enables rapid, accurate and easy control of a terminal connected through USB.

Example embodiments of the present invention also provide a device for performing the method of controlling a USB terminal

In some example embodiments, a method of controlling a USB terminal includes: providing, at a control device, a terminal control module for controlling a terminal connected through USB to the terminal through USB; providing, at the control device, a control command to the terminal control module through USB; executing, at the terminal control module, the control command, and capturing and providing, to the control device, a display image of the execution result; and displaying, at the control device, the display image.

Here, providing, at the control device, the terminal control module for controlling the terminal connected through USB to the terminal through USB may include: providing, at the control device, the terminal control module to the terminal; providing, at the control device, an execution control command for executing the terminal control module stored in the terminal; and executing, at the terminal, the terminal control module in response to the execution control command.

Here, the method may further include, after displaying, at the control device, the display image: providing, at the control device, a control end command for finishing control of the terminal to the terminal; and finishing, at the terminal, execution of the terminal control module in response to the control end command.

In other example embodiments, a device for controlling a USB terminal includes: a control module configured to provide a terminal control module for controlling a terminal connected through USB to the terminal through USB, provide a control command corresponding to an instruction of a user to the terminal through USB, receive a display image showing a result obtained by executing the control command from the terminal control module, and display the display image; and a USB driver configured to transfer the control command to the terminal and transfer the display image to the control module.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an environment in which a method of controlling a Universal Serial Bus (USB) terminal according to an example embodiment of the present invention is performed;

FIG. 2 shows function blocks of a device for controlling a USB terminal according to an example embodiment of the present invention; and

FIG. 3 is a flowchart illustrating a method of controlling a USB terminal according to an example embodiment of the present invention.

### DETAILED DESCRIPTION

Example embodiments of the present invention are disclosed herein.

However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the accompanying drawings. Like numbers refer to like elements throughout the description of the figures, and the description of the same component will not be reiterated.

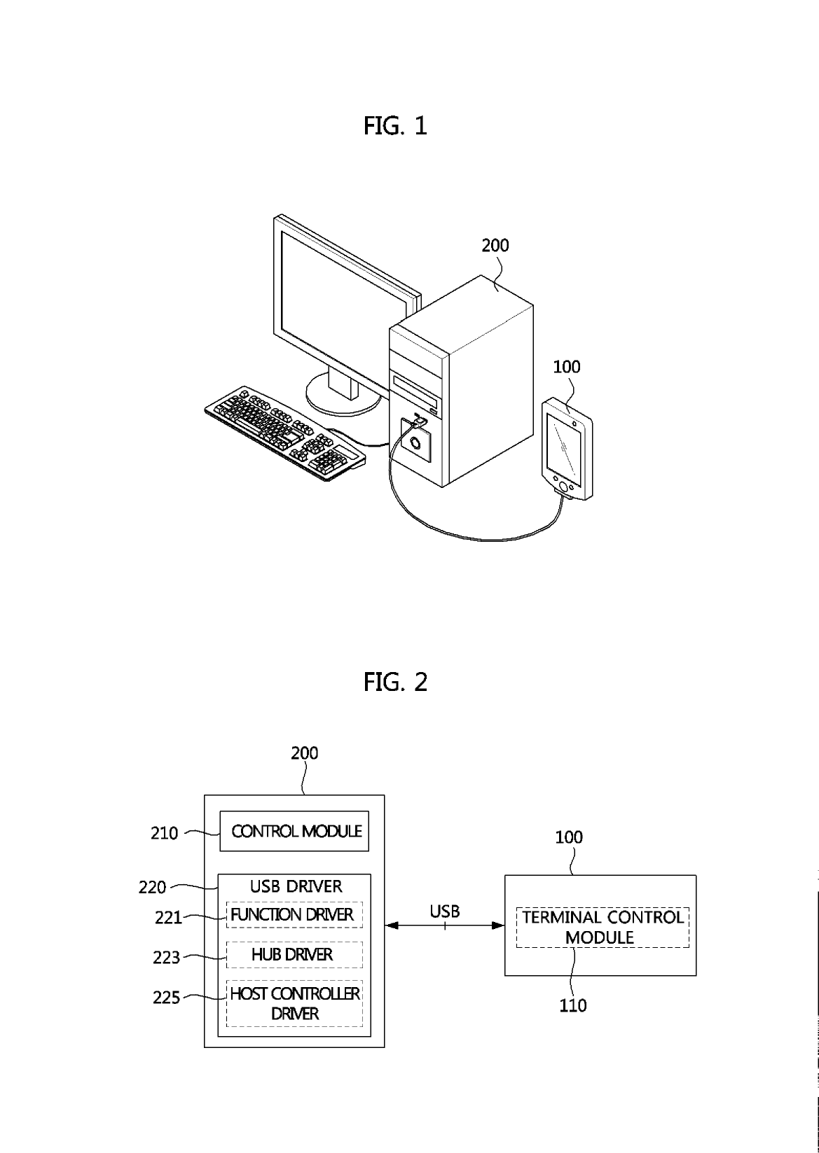

FIG. 1 is a conceptual diagram illustrating an environment in which a method of controlling a Universal Serial Bus (USB) terminal according to an example embodiment of the present invention is performed.

Referring to FIG. 1, a method of controlling a USB terminal according to an example embodiment of the present invention may be performed in an environment in which a mobile terminal 100 is connected with a control device 200 through a USB interface.

The mobile terminal 100 is a device that has a USB interface and performs a function of a USB device when connected with the control device 200. The mobile terminal 100 may be, for example, a mobile communication terminal such as a smart phone, a cellular phone and a personal digital assistant (PDA), or various digital information processing terminals such as a portable multimedia player (PMP), a smart player and a pad-type terminal.

The control device 200 may be various digital information processing devices, such as a desktop computer and a laptop computer, having a USB interface, and functions as a USB host when connected with the mobile terminal 100. The control device 200 may be, for example, a computer of a user (or expert) in an after-sales service center providing after-sales service for the mobile terminal 100.

The mobile terminal 100 is physically connected with the control device 200 through a USB cable or wireless USB by a user. In response to a direct request or command of the control device 200, the mobile terminal 100 performs the corresponding operation and then captures and provides a display image showing the operation result to the control device 200 through the USB interface.

The control device 200 functions as a physical host of the mobile terminal 100 connected through USB. Specifically, the control device 200 monitors whether a mobile terminal is connected to a USB port. When connection of the mobile terminal 100 is sensed, the control device 200 establishes a temporary communication path by setting a pipe capable of connecting an endpoint of the mobile terminal 100 with the host, and then requests device information (e.g., a device descriptor) from the mobile terminal 100.

When a response to the device information request is received from the mobile terminal 100, the control device 200 loads a function driver for driving the mobile terminal 100 into a memory on the basis of the received information (e.g., a vendor identification (ID) or a product ID), thereby performing a preparation process for controlling the mobile terminal 100.

Here, the control device 200 may be configured to, when there is no function driver of the mobile terminal 100, obtain the corresponding function driver using predefined information and then install the obtained function driver. For example, when there is no function driver, the control device 200 may access a predetermined device driver server using uniform resource locator (URL) information on the device driver server to download and install the corresponding function driver, or may access the server of the corresponding manufacturer using the vendor ID and the product ID provided from the mobile terminal 100 to download and install the corresponding function driver.

When the USB function driver of the mobile terminal 100 is installed as described above, the control device 200 provides a terminal control module (see 110 of FIG. 2) for controlling a mobile terminal to the mobile terminal 100 through USB, provides an instruction and/or data provided from the user to the mobile terminal 100 through the installed function driver, and receives and displays execution result data provided from the mobile terminal 100 or a captured display image.

FIG. 2 shows function blocks of a device for controlling a USB terminal according to an example embodiment of the present invention.

Referring to FIG. 2, a device 200 for controlling a USB terminal includes a control module 210 and a USB driver 220.

When a mobile terminal 100 is connected to the control device 200 through

USB, the control module 210 receives an interrupt indicating that the mobile terminal 100 is connected from a hub driver 223 to sense that the mobile terminal 100 is connected through USB. Thereafter, the control module 210 receives device information on the mobile terminal 100 (e.g., a vendor ID and a product ID) provided from the hub driver 223, reads a function driver 221 of the mobile terminal 100 from a storage (not shown) on the basis of the received device information, and loads the function driver into a memory, thereby installing the USB driver 220 for controlling the mobile terminal 100.

Here, the control module 210 may provide the device information on the mobile terminal 100 to an operating system (OS) of the control device 200, and the OS may be configured to determine whether there is the function driver 221 of the mobile terminal 100 by comparing the device information with registry information stored in the control device 200 and load the function driver 221 into the memory when there is the function driver 221 of the mobile terminal 100. On the other hand, when the function driver 221 of the mobile terminal 100 is not in the control device 200, the control module 210 may receive information on the function driver 221 from the OS of the control device 200 and determine whether or not there is the function driver 221.

When it is determined that the function driver 221 corresponding to the mobile terminal 100 is not in the control device 200, the control module 210 may access a predetermined device driver server using predetermined address information to download and install the function driver 221, or may access the server of the corresponding manufacturer using the device information provided from the mobile terminal 100 to download and install the function driver 221.

When the USB driver 220 for driving the mobile terminal 100 is installed on the control device 200 as described above, the control module 210 provides a terminal control module 110 to the mobile terminal 100 through the USB driver 220. Here, the control module 210 may be configured to include the terminal control module 110, automatically provide the terminal control module 110 to the mobile terminal 100 after the mobile terminal is connected to the control device 200 through USB, or passively provide the terminal control module 110 to the mobile terminal 100 in response to an instruction of a user after the USB driver 220 of the mobile terminal 100 is installed on the control device 200.

Also, the control module 210 provides a command for executing the terminal control module 110 stored in the mobile terminal 100 to the mobile terminal 100 through the USB driver 220, and the mobile terminal 100 executes the stored terminal control module 110 in response to the command. Here, the control module 210 may provide the terminal control module 110 to the mobile terminal 100, and then automatically provide the command for executing the terminal control module 110 to the mobile terminal 100 or provide the execution command to the mobile terminal 100 in response to an instruction of the user.

The terminal control module 110 executed in the mobile terminal 100 may capture and provide a display image currently displayed on the mobile terminal 100 to the control module 210 through the USB driver 220, and the control module 210 displays the display image provided from the mobile terminal 100.

Here, the terminal control module 110 of the mobile terminal 100 may be configured to capture and provide a display image to the control module 210 at predetermined time intervals or only when there is a change in a screen. Alternatively, the terminal control module 110 of the mobile terminal 100 may compare a captured image with a previously captured image and only provide a difference between the two images to the control module 210.

The device driver 220 may include the function driver 221, the hub driver 223 and a host controller driver 225.

The function driver 221 (or a client driver) manages communication between the control module 210 in its upper layer and the hub driver 223 in its lower layer. The function driver 221 may be configured as at least one file, and may be, for example, a class driver provided by the manufacturer of the mobile terminal 100. The class driver manages communication limited to the mobile terminal 100 or a class of the mobile terminal 100. The function driver 221 and the hub driver 223 may communicate with each other using a separately prepared format (e.g., an input/output (I/O) request packet).

The hub driver 223 is a driver that manages communication with a system hub of the control device 200. When the mobile terminal 100 is connected to the control device 200, the hub driver receives an interrupt indicating that the mobile terminal 100 is connected from the host controller driver 225 in its lower layer, establishes a temporary communication path with an endpoint of the mobile terminal 100 by setting a pipe in response to the interrupt, and then transmits a signal requesting device information to the mobile terminal 100 through the host controller driver 225. Thereafter, the hub driver 223 receives device information on the mobile terminal 100 from the host controller driver 225 in its lower layer, and provides the received device information to the control module 210.

The host controller driver 225 manages communication between the hub driver 223 and host controller hardware (not shown) connected to a hub. In other words, the host controller driver 225 transfers data provided from the hub driver 223 to the host controller hardware. Then, the data is transferred to the hub to which the mobile terminal 100 is physically connected, and the hub hands the data over to the mobile terminal 100. Also, data provided to the hub from the mobile terminal 100 is provided to the host controller driver 225 through the host controller hardware connected with the hub, and the host controller driver 225 transfers the received data to the hub driver 223 in its upper layer.

When an event instructing finish of control of the mobile terminal 100 occurs, the control module 210 transmits an execution end command for the terminal control module 110 that is being executed in the mobile terminal 100 to the mobile terminal 100. Here, when control of the mobile terminal 100 is finished, the control module 210 may transmit a command for removing the terminal control module 110 stored in the mobile terminal 100 to the terminal control module 110.

The mobile terminal 100 may finish execution of the terminal control module 110 on the basis of the execution end command or the removal command, and then remove the terminal control module 110.

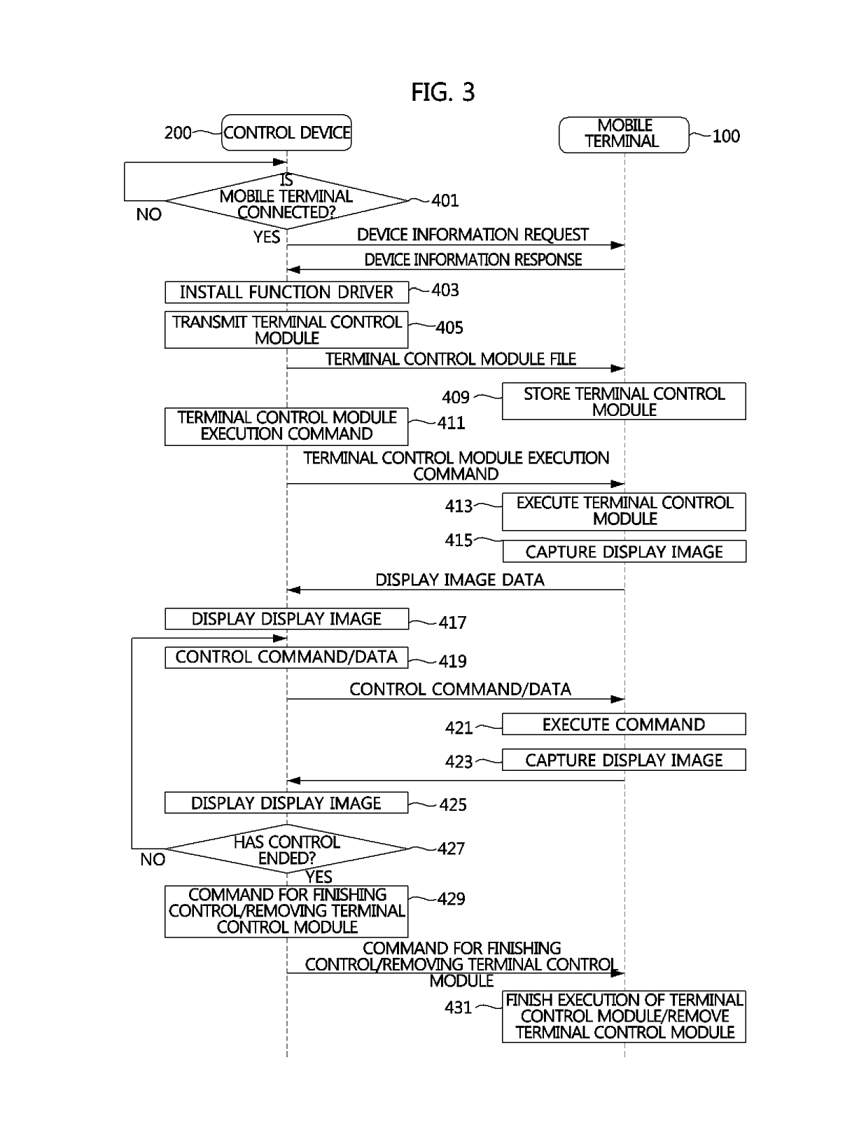

FIG. 3 is a flowchart illustrating a method of controlling a USB terminal according to an example embodiment of the present invention.

Referring to FIG. 3, a control device 200 determines whether a mobile terminal 100 is connected through USB (step 401). When it is determined that the mobile terminal 100 is connected, the control device 200 provides a device information request signal to the mobile terminal 100 and receives device information including a vendor ID and a product ID from the mobile terminal 100.

Subsequently, the control device 200 installs a function driver corresponding to the mobile terminal 100 on the basis of the received device information (step 403).

When the function driver for controlling the mobile terminal 100 is installed on the control device 200 as described above, the control device 200 transmits a terminal control module for controlling the mobile terminal 100 to the mobile terminal 100 through the USB driver (step 405), and the mobile terminal 100 receives and stores the terminal control module (step 409).

Here, the terminal control module may be automatically transmitted to the mobile terminal 100 after the USB driver is installed on the control device 200, or the control device 200 may provide the terminal control module to the mobile terminal 100 in response to an instruction of a user.

Subsequently, the control device 200 provides a command for executing the terminal control module stored in the mobile terminal 100 to the mobile terminal 100 through the USB driver (step 411), and the mobile terminal 100 executes the stored terminal control module in response to the command for executing the terminal control module (step 413).

Subsequently, the terminal control module executed in the mobile terminal 100 captures and provides a display image currently displayed on the mobile terminal 100 to the control device 200 (step 415), and the control device 200 displays the display image provided from the mobile terminal 100 (step 417).

When the user gives an instruction for controlling the mobile terminal 100 while looking at the display image of the mobile terminal 100, the control device 200 provides a control command or data corresponding to the given instruction to the mobile terminal 100 through the USB driver (step 419).

The mobile terminal 100 executes the command provided from the control device 200 (step 421), and then captures and transmits a display image showing the command execution result to the control device 200 (step 423).

The control device 200 receives and displays the display image of the mobile terminal 100 (step 425).

Steps 419 to 425 may be repeated while the mobile terminal 100 is controlled, and when an instruction for finishing control of the mobile terminal 100 is given by the user, the control device 200 provides a command for finishing the terminal control module that is being executed in the mobile terminal 100 to the mobile terminal 100 (step 429).

When the command for finishing the terminal control module is received, the mobile terminal 100 finishes execution of the terminal control module that is being executed (step 431).

Here, if control of the mobile terminal 100 is finished, the control device 200 may provide a command for removing the terminal control module installed on the mobile terminal 100 as well as the control end command to the mobile terminal 100, and in response to the commands, the mobile terminal 100 may remove the installed terminal control module after finishing execution of the terminal control module.

In the above-described method of controlling a USB terminal, the above-described device for controlling a USB terminal senses connection of a mobile terminal through USB, provides a terminal control module to the mobile terminal through an installed USB driver to install the terminal control module on the mobile terminal, and provides a control command and/or data corresponding to control of a user to the terminal control module through the USB driver. After executing the control command provided from the control device, the terminal control module installed on the mobile terminal captures and provides a display image showing the execution result to the control device, and the control device displays the display image provided from the mobile terminal.

Consequently, it is possible to readily and rapidly control a mobile terminal by simply connecting the mobile terminal to the control device through USB, and the mobile terminal can be more accurately controlled through display of a result screen obtained by executing a control command in the mobile terminal.

While the example embodiments of the present invention and their advantages have been described in detail, it should be understood that various changes, substitutions and alterations may be made herein without departing from the scope of the invention.

What is claimed is:

1. A method of controlling a Universal Serial Bus (USB) terminal, comprising:
providing, at a control device, a terminal control module for controlling a terminal connected through USB to the terminal through USB;
providing, at the control device, a control command to the terminal control module through USB;
executing, at the terminal control module, the control command, and capturing and providing, to the control device, a display image of the execution result; and
displaying, at the control device, the display image.

2. The method of claim 1, wherein providing, at the control device, the terminal control module for controlling the terminal connected through USB to the terminal through USB includes:
providing, at the control device, the terminal control module to the terminal;
providing, at the control device, an execution control command for executing the terminal control module stored in the terminal; and
executing, at the terminal, the terminal control module in response to the execution control command.

3. The method of claim 1, further comprising, after displaying, at the control device, the display image:
providing, at the control device, a control end command for finishing control of the terminal to the terminal; and
finishing, at the terminal, execution of the terminal control module in response to the control end command.

4. A device for controlling a Universal Serial Bus (USB) terminal, comprising:
a control module configured to provide a terminal control module for controlling a terminal connected through USB to the terminal through USB, provide a control command corresponding to an instruction of a user to the terminal through USB, receive a display image showing a result obtained by executing the control command from the terminal control module, and display the display image; and
a USB driver configured to transfer the control command to the terminal and transfer the display image to the control module.

5. The device of claim 4, wherein, when an event instructing finish of control of the terminal occurs, the control module provides a command for finishing execution of the terminal control module and removing the terminal control module to the terminal.
